(19) United States
(12) Patent Application Publication
(10) Pub. No.: US 2006/0236264 A1
(43) Pub. Date: Oct. 19, 2006

(54) Automatic window resize behavior and optimizations

(75) Inventors: Jonathan Marshall Cain, Seattle, WA (US); Judson Craig Hally, Sammamish, WA (US); Jeremy Scott Knudsen, Monroe, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/108,335

(22) Filed: Apr. 18, 2005

(51) Int. Cl. G06F 9/00

(52) U.S. Cl. 715/788; 715/800; 715/815

(57) ABSTRACT

A method and system for managing the layout of an application window during a resize operation. An application is responsive to a resize request to automatically resize the application window to have minimum height and/or width the dimensions when the user adjusts one or more of the window's dimensions below a threshold value. The application is also responsive to the resize request to selectively add or remove control components from the user interface in response to size adjustments to the window being made by the user.

### TECHNICAL FIELD

The present invention relates to the field of processing digital media content. In particular, this invention relates to improved user interfaces and media player functionality for enhancing user experience.

### BACKGROUND OF THE INVENTION

Due to recent advances in technology, computer users are now able to enjoy many features that provide an improved user experience when using various software applications on their personal or laptop computers. For example, most computers today run media player applications able to play media files such as those found on compact discs (CDs). This allows users to listen to their favorite musical artists while working on their computers. Many computers are also equipped with digital versatile disc (DVD) drives enabling users to watch movies.

A typical application provides an application user interface (UI) that allows the user to interact with the application. In general, UIs provide controls or buttons that the user engages to cause a predetermined result. A software application such as a media player may have several buttons, often referred to as transport controls, permits the user to play, pause, fast-forward, reverse, and control the volume of a particular piece of media being rendered by the player. In the past, UIs have been generally fixed insofar as their layout and functionality are concerned. One primary reason for this stems from the desire to impart standardization to various UIs. Yet, against the backdrop of standardized UIs, there is a desire to impart UIs with a more user friendly, aesthetically pleasing look and improved functionality.

For instance, the UI is often viewed as a window that includes various controls for interacting with the application or data (e.g., files) accessible via the application. Such applications windows generally have a default dimensions (i.e., height x width), which can be modified (i.e., resized) by the user. However, the ability to resize such windows can be both powerful and problematic. Resizing is powerful because it gives users the ability to tailor their viewing experience based on preferences and circumstances. For example, a user running a screen display size of 1600 pixels×1200 pixels may choose to view two windows side by side or maximize the windows and toggle between them. Another user might have a screen display size of 800×600 and find it impractical to have more than one window in view at a time. Yet another user might have multiple displays and choose to have several windows in view at once where each window is sized to best display the content it contains. This flexibility gives users the power to choose their own viewing experience, tailor windows sizes to best view the content they contain, as well as optimize for their computer configuration.

Unfortunately, this resize ability can be problematic because software designers and developers cannot always anticipate or design for the variables in user preferences or display configurations. It is common for windows to be resized down to such small sizes that their content becomes unusable. As windows become smaller, the content and surrounding controls usually get clipped or truncated. It is common for windows to be resized down to views that only contain scrollbars and toolbars. Such views are confusing, cluttered, and relatively unusable.

Accordingly, this invention arose out of concerns for providing improved systems and methods for interacting with application windows that provide an improved, rich, and robust user experience.

### SUMMARY OF THE INVENTION

The invention meets the above needs and overcomes one or more deficiencies in the prior art by providing improved user experience when interacting with application windows in a user interface. In particular, aspects of the invention enhance a user's experience by selectively adding or removing control components or elements from the UI in response to size adjustments to the window being made by the user. In addition, the invention automatically toggles between optimum window sizes in response to a user adjusting the window below or above a certain size threshold. For example, the invention in at least one of its embodiments automatically resizes the window to one of a plurality of default sizes, including one having minimum height and/or width dimensions when the user adjusts a window dimension below a threshold value. Advantageously, the various features of the invention allow the user to interact with a minimized interface that is clean, simple, and usable. Thus, the software routines of the invention increase the attractiveness of the application interface to users. Moreover, the features of the present invention described herein are less laborious and easier to implement than currently available techniques as well as being economically feasible and commercially practical.

In accordance with one aspect of the invention, a method for managing an application window being displayed via a user interface is provided. The application window has at least one dimension representative of size. The method includes receiving input data from a user defining a requested size for the application window being displayed via the user interface. The method also includes resizing the application window to a selected one of a plurality of default sizes as a function of the requested size. The application window containing one or more pre-defined user interface elements for optimizing the user interface at the selected default size.

In accordance with another aspect of the invention, a computer system having a graphical user interface including a display and a user interface selection device provides a method of modifying an application window on the display. The application window has a height and a width. The method includes receiving size data from a user via the user interface selection device. The size data is representative of a desired size of the application window being displayed via the graphical user interface, and specifies a desired height and width of the application window. The method also includes comparing the specified height and width of the application window to a threshold height and width, and resizing the application window to have the specified height and specified width when the specified height and width are greater than the threshold height and width, respectively. The method also includes resizing the application window to a predetermined minimum height and width when the specified height and width are less than the threshold height and width, respectively. The application window at the predetermined minimum height and width contains one or more pre-defined user interface elements for optimizing the user interface.

In accordance with yet another aspect of the invention, one or more computer-readable media having computer-executable components for managing an application window being displayed via a user interface is provided. The application window includes at least one dimension defining the size thereof. The components include a user interface component for receiving input data from a user, said input data defining a requested size for the application window being displayed via the user interface. A comparing component compares the requested size of the application window to a threshold size. A resizing component resizes the application window to a selected one of a plurality of default sizes as a function of the requested size. The application window contains one or more pre-defined user interface control elements for optimizing the user interface at the selected default size.

Computer-readable media having computer-executable instructions for performing methods of managing application windows embody further aspects of the invention.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram of a computer system embodying aspects of an embodiment of the present invention.

FIG. 2 is a screen shot illustrating an exemplary application window being displayed on a display according to an embodiment of the invention.

FIG. 3 is a screen shot of the application window resized from an initial size to a desired size without the advantages of the present invention.

FIG. 4 is a block diagram illustrating the components of a computer application according to an embodiment of the invention.

FIGS. 5A and 5B are screen shots of a window, before and after resizing, respectively.

FIGS. 5C is a screen shot of a drop down menu displaying exemplary functions corresponding to control components displayed in the window of FIGS. 5A and 5B.

FIG. 6 is an exemplary flow chart illustrating a method of managing the resizing of an application window according to an embodiment of the invention.

FIG. 7 is a block diagram illustrating one example of a suitable computing system environment in which the invention may be implemented.

Corresponding reference characters indicate corresponding parts throughout the drawings.

### DETAILED DESCRIPTION OF THE INVENTION

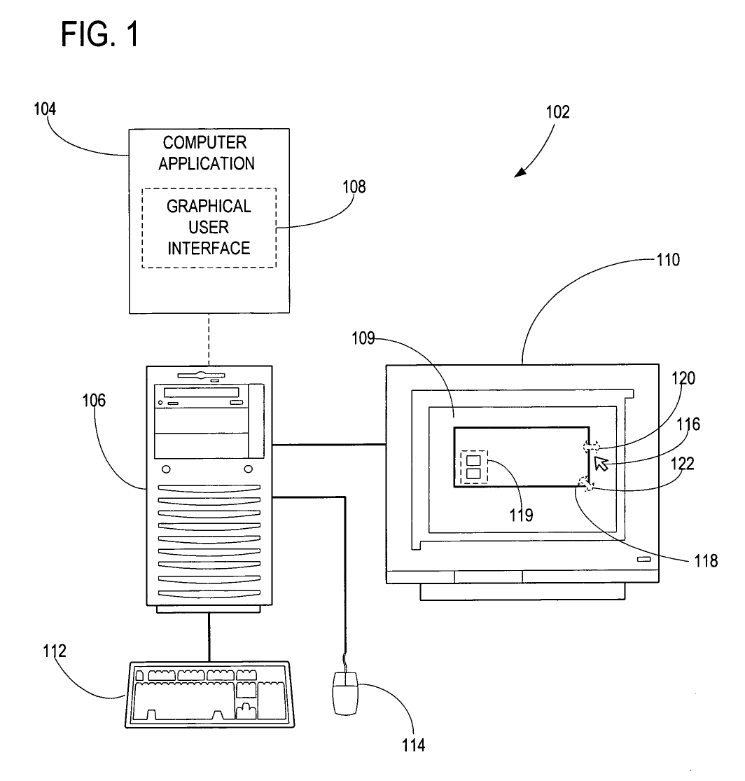

FIG. 1 illustrates basic components of a computer system 102 used in connection with one embodiment of the present invention. Aspects of the invention relate to a computer application 104 that, when executed by a computer 106, renders media content and retrieves, stores, and displays contextual information via a graphical user interface (UI) 108. The UI 108 is presented to a user on a computer display screen 109 of a monitor 110 of the computer system 102. The UI 108 is preferably implemented as part of an operating system that provides an environment for displaying and managing window objects of the operating system. Although the present invention is described in conjunction with a conventional desktop computer, it will be appreciated that the present invention may be utilized in other types of computer systems that use a window-based display system. In one embodiment, the computer 106 receives input data from an input device such as a conventional keyboard 112. Those skilled in the art are familiar with the use of cursor keys on the keyboard 112, a mouse 114, trackball, or other pointing device to move a cursor 116 on the display 109 for the selection of various options. It should be appreciated by those skilled in the art that text entry or command input also may be accomplished by using a touch-sensitive pad or handwriting recognition device in conjunction with software for recognizing the corresponding input signals as selection signals.

As an example, one way that people often work on computer screen is with a window 118. The window 118 is typically a rectangular area on the display 109 used to display information or receive commands or data from the user. The window 118 receives user input from the keyboard 112, mouse 114, or other input device, and displays graphical output upon which a user may interact. The display 109 thereby serves as the workspace for the computer 106. The computer application 104 is responsible for generating the window 118 and for responding to user interactions with the window 118. The window 118 may include the computer program's title bar across the top of the window 118, menus, sizing borders, and other objects. The window 118 may also contain additional discrete sub-elements such as push buttons, radio buttons, and checkboxes, and “child windows” which are simply smaller windows contained within the parent window. Child windows may take the form of control elements or components 119 (e.g., video display windows, web page windows, text document windows, text entry fields, list boxes, and scroll bars, and the like). These components 119 when displayed on the computer screen 109 may be pressed or clicked or scrolled. For example, a user sees a window as an object on the screen, and interacts directly with the object by clicking on control components 119, or scrolling a scroll bar, or tapping a handle displayed in the window 118.

The window 118 may be expanded or contracted to a variety of different sizes and shapes by pulling any side of the window 118 outward or by pushing a side of the dialog window inward. In one embodiment, when the mouse cursor 116 is positioned over a particular border of the window 118 the cursor 116 transforms into a double-headed arrow, as indicated in phantom at 120. By clicking and holding mouse 114 while the double arrow 120 is positioned over the particular border, the user can drag the border of window 118 inward or outward to make the window 118 smaller or larger as desired. For example, by clicking and holding mouse 114 when the double-headed arrow 120 is positioned over the top border or bottom border of window 118, the user can drag the top or bottom border up or down to decrease or increase, respectively, the height of the window 118. As another example, by clicking and holding mouse 114 when the double-headed arrow 120 is positioned over the right border or left border of window 118, the user can drag the right or left border inward or outward to decrease or increase, respectively, the height of window 118. To change both height and width at the same time, the mouse cursor 114 may be positioned over a corner of the window 118 and becomes a diagonal double-headed arrow, as indicated in phantom at reference character 122. It should be understood that the window 118 may be resized through other means, including resizing tabs and/or keyboard entries directed to the changing dimension of the dialog window.

The system 102 allows improved management of an application window 118 of a UI 108 when a user resizes the window 118 being displayed on the display 109. More specifically, the present invention selectively adds or removes control components from the window, and/or selectively resizes the window to preset height and/or width dimensions during a resize operation being performed by the user.

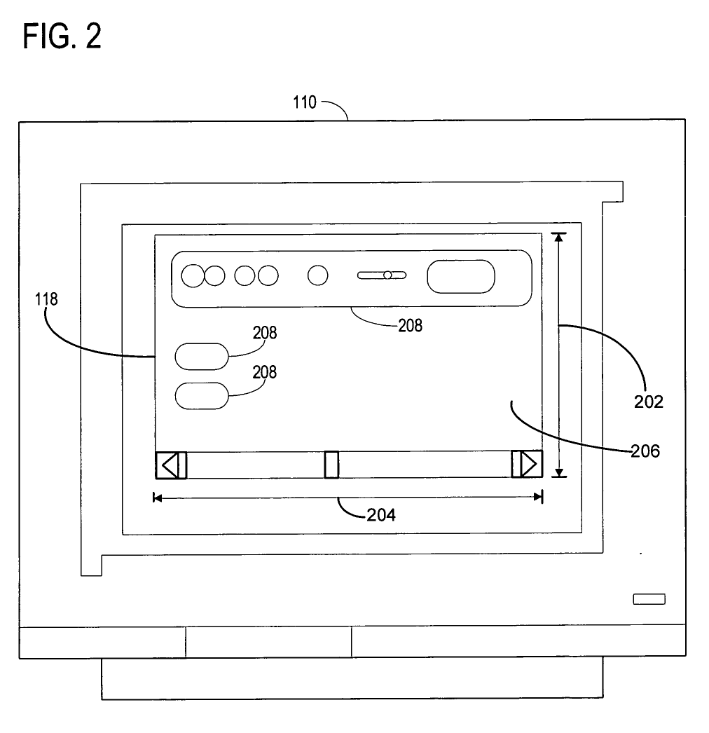

FIG. 2 is a screen shot illustrating an exemplary application window 118 prior to a resize operation (e.g., full size). The window height, as indicated by dimension line 202, and the window width, as indicated by dimension line 204, can be defined in pixels. For example, the window 118 may have an initial size, or default size, defined as 800 pixels high by 600 pixels wide. The window 118 includes a visible region 206 displaying, for example, media content such as movie clips, album art, etc. As the size of the window 118 changes, the size of the visible region 206 also changes size. The window typically includes control components 208 for implementing one or more functions offered by the application. For example, the control components 208 may include a main toolbar, scroll bars, various command buttons (e.g., open, file, playback controls for controlling the playback of a media file etc.) As described above, when the dimensions of window 118 are reduced below threshold values, some of the control components 208 may be clipped, truncated or totally hidden from view. This results in a window 118 that can be confusing, cluttered, and relatively unusable to the user.

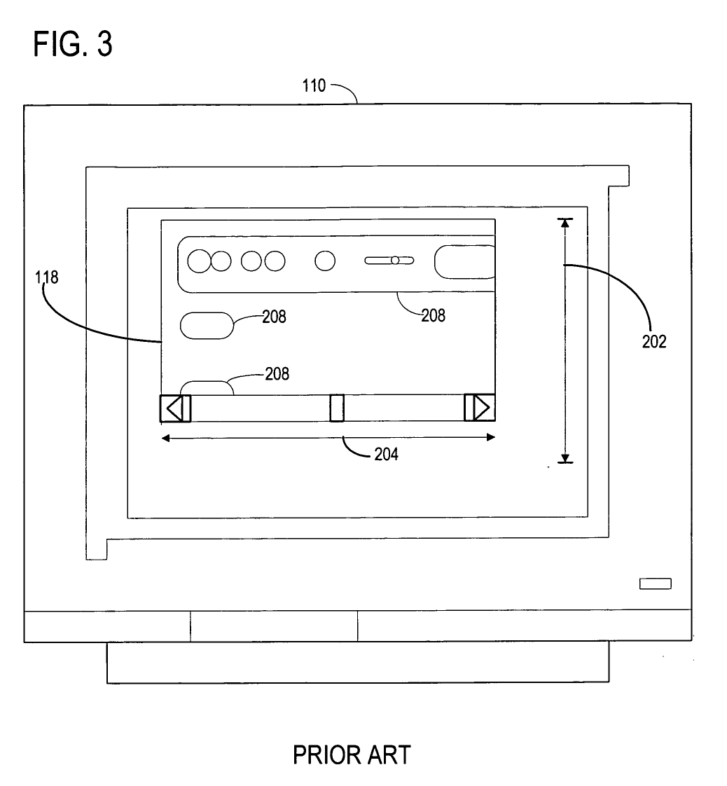

Referring now to FIG. 3, a screen shot illustrating an exemplary application window 118 after a resize operation without the advantages of the present invention. As described above, various methods can be used to resize the window 118. However, for purposes of illustration only, the following description assumes the window resizing operation is being performed by dragging a double-headed arrow such as described above in reference to FIG. 1. As the user resizes application window 118 with the mouse 114, the computer application 104 provides a message to application window 118 specifying the current size of the window 118 as adjusted by the user. For example, using the initial dimensions of the window as 800 pixels high by 600 pixels wide, when the user decreases the size of the window 118 by dragging the lower-right corner inward, the application 104 receives a number of requests for smaller dimensions (e.g.—768×588, then 752×581, 745×571, etc.) until the user reaches a desired window size (e.g., 700 pixels wide by 500 high). As can be seen from FIG. 3, when the user resizes the window 118 below a certain threshold, some of the control components 208 appear clipped or truncated, and the visible region 206 is reduced in size.

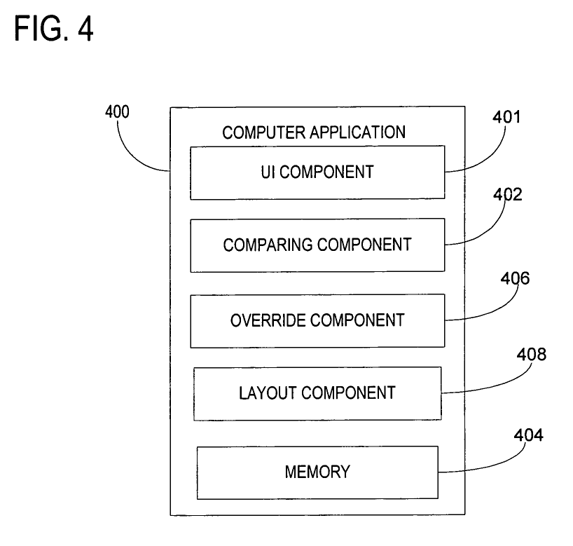

Referring now to FIG. 4, a block diagram illustrates the components of a computer application 400 (e.g., application 104) configured to override a resize request that could potentially result in the clipping or truncating of control components 208 being displayed in the window 118. The application 400 includes a UI component 401 for receiving a resize request from a user. The application 400 is responsive to the resize request to execute a comparing component 402 to determine whether dimensions specified by the resize request are less than threshold dimension values stored in a memory 404 associated with application 400. For example, the comparing component 402 determines if the window height specified in the resize request is less than a predetermined threshold height or “snapping” height. If the height specified in the resize request is less than the snapping height, the application 400 executes an override component 404 to set the height of the window equal to the minimum height value stored in a memory 404 of the application 400. If the width specified in the resize request is less than a predetermined threshold width or “snapping” width and the requested height is less than the snapping height, the override component 406 sets the height and width of the window 118 to equal the minimum height and width, respectively. In this particular embodiment, the override component 406 will not override the specified width if the specified height is less than the snapping height. As a further example, the following Table 1, illustrates the resulting height and width of a window 118 in response various to resize request when the predetermined snapping height is 400 pixels, the predetermined snapping width is 450 pixels, a minimum height value of 200 pixels, and a minimum width value of 300 pixels.

TABLE 1

| | C1 | C2 |
|---|---|---|
| | REQUESTED | RESULTING |
| | HEIGHT/WIDTH | HEIGHT/WIDTH |
| | (Pixels) | (Pixels) |
| R1 | 800/600 | 800/600 |
| R2 | 768/521 | 768/521 |
| R3 | 500/400 | 500/400 |
| R4 | 380/400 | 200/300 |
| R5 | 380/451 | 200/451 |

Columns C1 and C2 corresponds to the requested and resulting heights/widths, respectively, for the window. Each of the rows (R1-R5) corresponds to a particular requested height/width and a corresponding resulting height/width. For a requested height/width of 800 pixels high by 600 pixels wide (i.e., see cell located at R1 and C1 in Table 1; hereinafter referred to as R1C2), the resulting height/width of the window is of 800 pixels high by 600 pixels wide (See R1C2). In this case, since the requested window height of 800 pixels is greater than the predetermined snapping height of 400 pixels, and the requested width of 600 is greater than the predetermined snapping width of 450 pixels, the resulting dimensions are equal to the requested dimensions. For a requested height/width of 380 pixels high by 400 pixels wide (See R4C1), the resulting height/width of the window is of 200 pixels high by 300 pixels wide (See R4C2). In this instance, since the requested window height of 380 pixels is less than the predetermined snapping height of 400 pixels, and the requested width of 300 is less than the predetermined snapping width of 450 pixels, the resulting dimensions are equal to the minimum height and width values stored in the memory 404 (e.g., 200 pixels high by 300 pixels wide). As another example, a requested height/width of 380 pixels high by 451 pixels wide (See R5C1), the resulting height/width of the window is of 200 pixels high by 451 pixels wide (See R4C2). In this example, since the requested window height of 380 pixels is less than the predetermined snapping height of 400 pixels and the requested window width of 451 is greater than the predetermined snapping width of 450 pixels, the resulting height/width of the window is of 200 pixels high by 451 pixels wide (See R5C2). In this manner, embodiments of the invention define one or more default window sizes.

In one embodiment of the present invention, the application 400 is responsive to the resize request to execute layout component 408 to change the layout of UI 108 components displayed in the window based on the dimensions specified by the resize request. For example, the layout component 408 includes instructions for removing control components based on an importance property value assigned to each of the displayed control components and the height or width dimensions specified by the resize request. In one embodiment, the importance property value is assigned to a control component 208 heuristically based on an anticipated level of importance the control component 208 to the user using the application 400. For example, the importance value assigned to an open button may be greater than the importance value assigned to a cancel button to indicate that viewing the open button is likely more important to the user than viewing the cancel button. Similarly, the importance value assigned to the playback control may indicate that viewing the playback control is more important than viewing the open button. In this embodiment, the layout component 408 removes the control components assigned the lowest importance values or control components assigned importance values within a predetermined range, when the height or width dimensions specified by the resize request are less than a specified set of minimum height or width values stored in memory. As the user continues to decrease the size of the window 118, the layout component 408 removes the next control component, or control components, from the remaining controls components in the window 118 having the lowest importance value. When the user increases the sizes of the window 118, the layout component 408 adds control components to the window 118 in the reverse order in which they were removed.

In another embodiment, the layout component 408 changes the layout of control components by changing the relative positions of the control components displayed in the window 118. For example, the layout component 408 may change the positioning of Open and Cancel buttons to an over-under configuration as opposed to side-by-side configuration, when the height or width dimensions specified by the resize request are less than specified minimum height or width values.

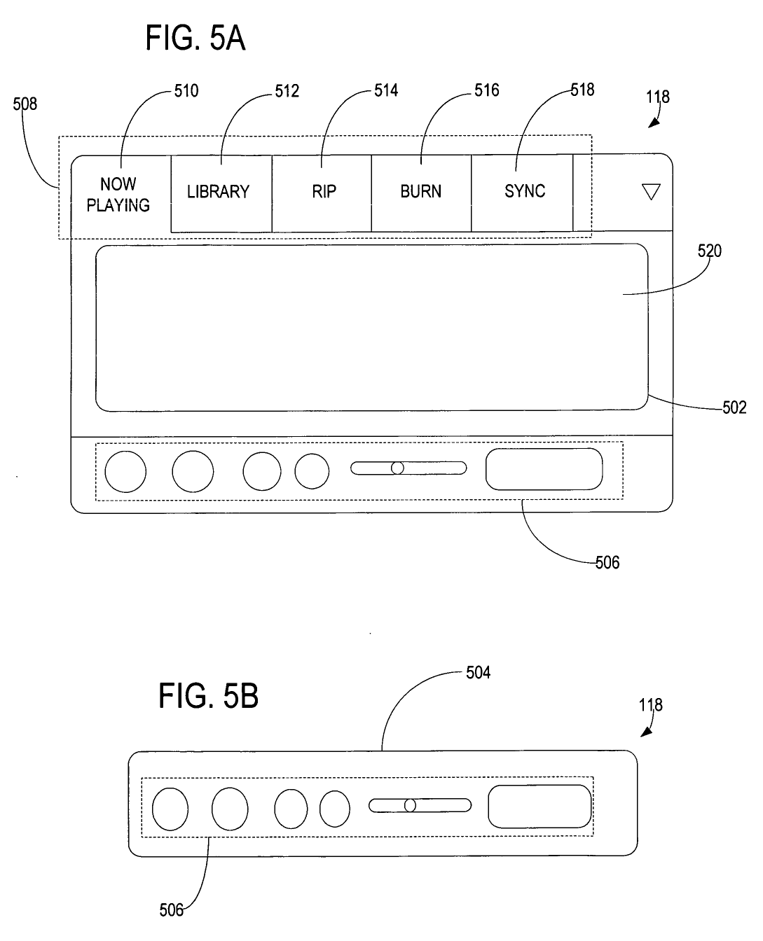

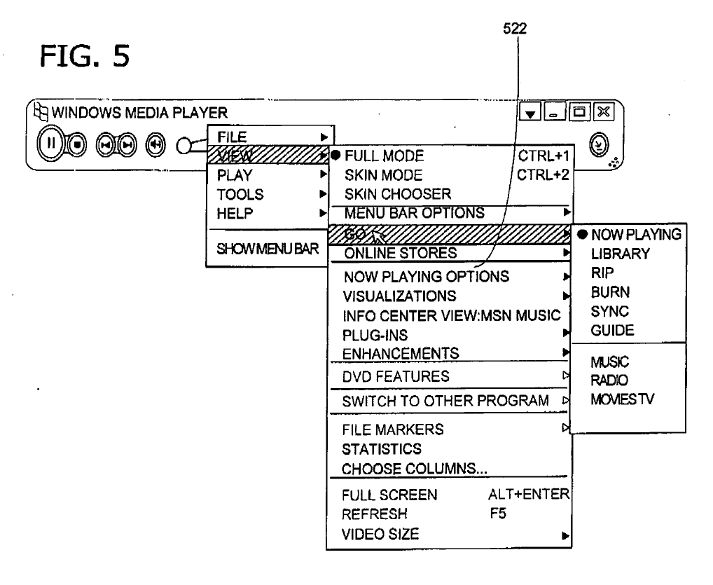

Referring now to FIGS. 5A and 5B, exemplary screen shots illustrate a pre-resized window 502 and resized minimum window 504, respectively. The window 502 before resizing includes user interface components such as a playback control 506 for controlling the playback of a media file or track and various control tabs 508 for providing a user various options for interacting with digital media content. In this particular example, the control tabs 508 include a now playing tab 510, a library tab 512, a rip tab 514, a burn tab 516, and a sync tab 518. For example, the user may select the library tab 512 to view or interact with tracks stored in a media library. Alternatively, the user may select the burn tab 516 to create a CD containing the user's favorite tracks. The pre-resized window 502 also includes a visible region 520 for displaying media content.

The default size of the resized minimum window 504 corresponds to an absolute minimum size at which the window 118 will be displayed when the height and/or width of the window 118 is decreased below a threshold height and/or width. In other words, after the size of window 118 is decreased below threshold dimensions, the window is displayed as resized minimum window 504 (see FIG. 5B). In this instance, the resized minimum window 504 retains the playback control 506, but the control tabs 508 and the visible region 520 are removed from the resized minimum window 504 to provide user interface that is clean, simple, and usable. In other words, aspects of the invention permit displaying the user interface elements that are most important to the user rather than merely clipping, truncating, or hiding these elements to fit the resized window.

Notably, although the control tabs and/or other components may be removed from the window 118, the user does not loose functionality associated with control components removed from the window because the functions performed by the removed control tabs (e.g., Now Playing, Library, Rip, Burn, and Sync) may be accessed by clicking the mouse while the cursor is positioned over the resized minimum window 504 to display a drop down menu 522 such as show in FIG. 5C.

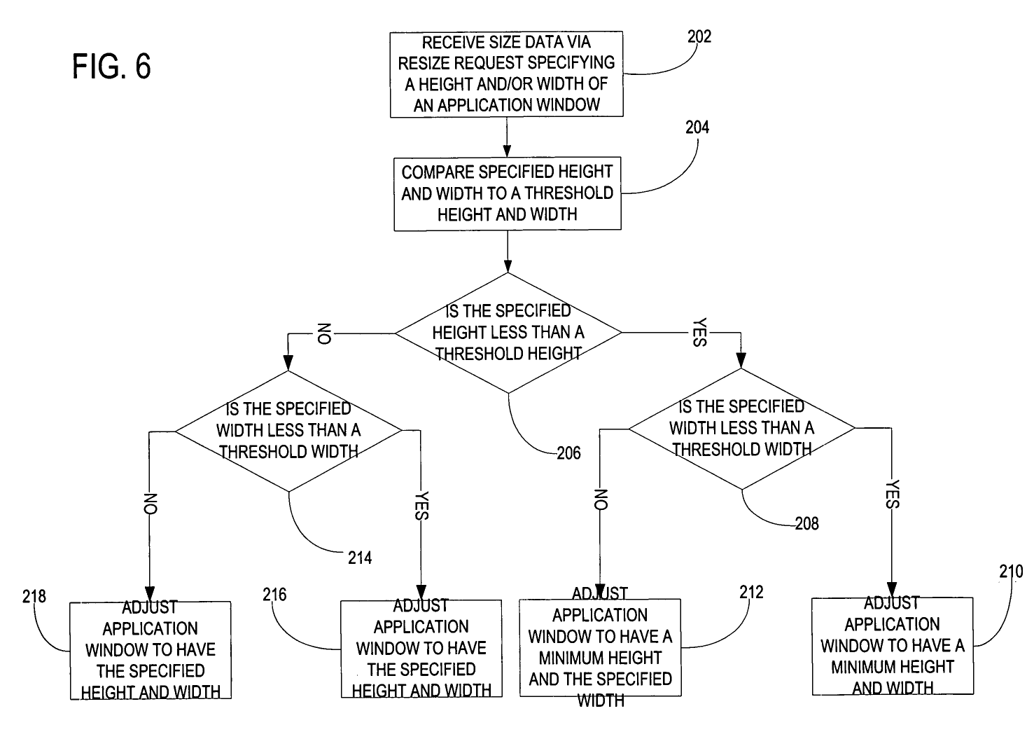

Referring now to FIG. 6, an exemplary flow chart illustrates a method of resizing an application window according to one embodiment of the invention. At 602, a resize request specifying a new height and width for an application window is generated in response to a user interacting with the window to change the size of the window. The application 104 compares the specified height and width with threshold height and width values, respectively, stored in a memory at 604. At 606, the application 104 determines if the specified height is less than the threshold height. If the specified height is determined not to be less than (i.e., greater than) the threshold height at 606, then the application 104 determines if the specified width is less than the threshold width at 608. If the specified width is determined not to be less than (i.e., greater than) the threshold width at 608, then the application adjusts the application window to have a minimum height and the specified width at 610. If the specified width is determined to be less than the threshold width at 608, the application 104 adjust the application window to have a minimum height and the minimum width at 612. If the specified height is determined to be less than the threshold height at 606, then the application 104 determines if the specified width is also less than the threshold width at 614. If the specified width is determined not to be less than (i.e., greater than) the threshold width at 608, then the application 104 adjusts the application window to have the specified height and width values at 610. If the specified width is determined to be less than the threshold width at 608, the application 104 adjusts the application window to have the specified height and width at 612.

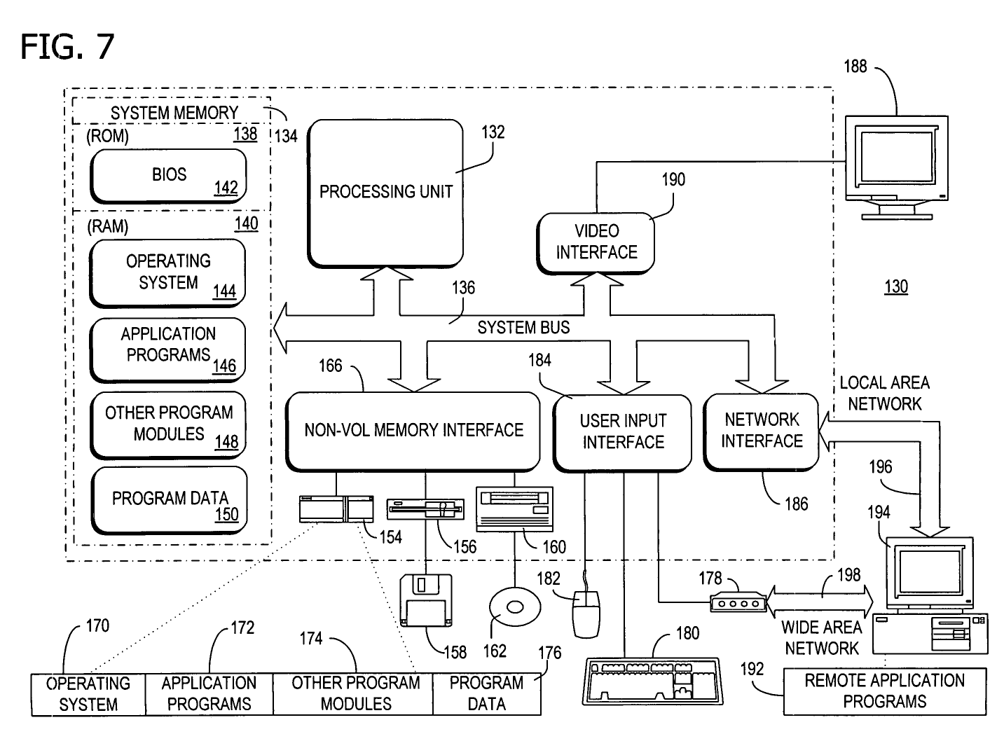

FIG. 7 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between components within computer 130, such as during start-up, is typically stored in ROM 138. RAM 140 typically contains data and/or program modules that are immediately accessible to and/or presently being operated on by processing unit 132. By way of example, and not limitation, FIG. 7 illustrates operating system 144, application programs 146, other program modules 148, and program data 150.

The computer 130 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 7, provide storage of computer readable instructions, data structures, program modules and other data for the computer 130. In FIG. 7, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the components described above relative to computer 130. The logical connections depicted in FIG. 7 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 7 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in FIG. 6.

The order of execution or performance of the methods illustrated and described herein is not essential, unless otherwise specified. That is, components of the methods may be performed in any order, unless otherwise specified, and that the methods may include more or less components than those disclosed herein. For example, it is contemplated that executing or performing a particular component before, contemporaneously with, or after another component is within the scope of the invention.

When introducing components of the present invention or the embodiment(s) thereof, the articles “a,” “an,” “the,” and “said” are intended to mean that there are one or more of the components. The terms “comprising,” “including,” and “having” are intended to be inclusive and mean that there may be additional components other than the listed components.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

1. A method of managing an application window displayed via a user interface, said application window having at least one dimension representative of size, said method comprising:
receiving input data from a user defining a requested size for the application window being displayed via the user interface; and
resizing the application window to a selected one of a plurality of default sizes as a function of the requested size, said application window containing one or more pre-defined user interface elements for optimizing the user interface at the selected default size.

2. The method of claim 1, wherein the user defines the requested by inputting a desired value of the application window dimension via a keyboard.

3. The method of claim 1, wherein the user defines the requested size by selecting and dragging one or more sides of the application window displayed in the user interface via a mouse.

4. The method of claim 1, wherein the user defines the requested size by selecting and dragging a corner of the application window displayed in the user interface via a mouse.

5. The method of claim 1, further comprising comparing the requested size of the application window to a threshold size and wherein resizing the application window to the selected default size includes resizing the application window to the threshold size when the requested size is smaller than the threshold size.

6. The method of claim 5, wherein the input data received from the user includes a requested dimension of the application window, and wherein comparing the requested size to the threshold size includes comparing the requested dimension to a threshold dimension.

7. The method of claim 6, wherein resizing the application window includes resizing the application window to the requested dimension when the requested dimension is greater than the threshold dimension.

8. The method of claim 6, wherein resizing the application window includes resizing the application window to a predetermined minimum dimension when the requested dimension is less than the threshold dimension.

9. The method of claim 6, wherein the dimension comprises one or more of the following: height and width.

10. The method of claim 1, wherein one or more computer readable media have computer-executable instructions for performing the method of claim 1.

11. In a computer system having a graphical user interface including a display and a user interface selection device, a method of modifying an application window on the display, said application window having a height and a width, said method comprising:
receiving size data from a user via the user interface selection device, said size data being representative of a desired size of the application window being displayed via the graphical user interface, said size data specifying a desired height and width of the application window;
comparing the specified height and width of the application window to a threshold height and width;
resizing the application window to have the specified height and specified width when the specified height and width are greater than the threshold height and width, respectively, and
resizing the application window to a predetermined minimum height and width when the specified height and width are less than the threshold height and width, respectively, said application window at the predetermined minimum height and width containing one or more pre-defined user interface elements for optimizing the user interface.

12. One or more computer-readable media having computer-executable components for managing an application window being displayed via a user interface, said application window having at least one dimension defining the size thereof, said components comprising:
a user interface component for receiving input data from a user, said input data defining a requested size for the application window being displayed via the user interface;
a comparing component for comparing the requested size of the application window to a threshold size;
a resizing component for resizing the application window to a selected one of a plurality of default sizes as a function of the requested size, said application window containing one or more pre-defined user interface control elements for optimizing the user interface at the selected default size.

13. The computer-readable media of claim 12, wherein the resizing component includes computer-executable instructions for resizing the application window to the requested size when the requested sized is greater than the threshold size and for resizing the application window to the threshold size when the requested sized is less than the threshold size.

14. The computer-readable media of claim 12, wherein the user interface component receives input data from a user inputting height and width values via a keyboard.

15. The computer-readable media of claim 12, wherein the user interface component is responsive to a change in the position of a vertical border or a horizontal border of the application window to generate a resize request, said resize request defining the requested size of the window as a function of a current position of each of the vertical and horizontal borders.

16. The computer-readable media of claim 12, wherein input data received by the user interface component includes a requested height and/or a requested width, and wherein the comparing component includes computer-executable instructions for comparing the requested height and/or width to a threshold height and/or width, respectively.

17. The computer-readable media claim 16, wherein the resizing component includes computer-executable instructions for resizing the application window to the requested height when requested height is greater than the threshold height and to the requested width when the requested width is greater than the threshold height.

18. The computer-readable media claim 16, wherein the resizing component includes computer-executable instructions for resizing the application window to have a minimum height when the requested height is less than the threshold height and to have a minimum width when the requested width is less than the threshold width.

19. The computer-readable media claim 12, further comprising a layout component for changing a layout of the control elements contained in the application window when the requested sized is less than the threshold size.

20. The computer-readable media claim 19, wherein the layout component includes computer-executable instructions for removing one or more of the control elements from being displayed in the application window when the requested sized is less than the threshold size.
